(19) United States
(12) Patent Application Publication
(10) Pub. No.: US 2025/0196004 A1
(43) Pub. Date: Jun. 19, 2025

(54) GAME PICTURE DISPLAY METHOD AND APPARATUS, DEVICE, AND COMPUTER-READABLE STORAGE MEDIUM

(71) Applicant: Tencent Technology (Shenzhen) Company Limited, Shenzhen (CN)

(72) Inventors: Fengru Lu, Shenzhen (CN); Hao Hu, Shenzhen (CN); Kaihua Zhang, Shenzhen (CN); Junhong Wang, Shenzhen (CN)

(21) Appl. No.: 19/062,210

(22) Filed: Feb. 25, 2025

Related U.S. Application Data
(63) Continuation of application No. PCT/CN2024/072241, filed on Jan. 15, 2024.

(30) Foreign Application Priority Data
Mar. 7, 2023 (CN) 202310248919.1

(51) Int. Cl. A63F 13/53; A63F 13/837; A63F 13/92

(52) U.S. Cl. CPC A63F 13/53; A63F 13/837; A63F 13/92

(57) ABSTRACT

A game picture display method and an apparatus, a device, and a computer-readable storage medium for the gate display method, which belong to the field of computer technologies, are described. The method includes: displaying a first game picture, the first game picture including a first scene picture, a sight, and a conversion control, the sight being in an off state, and the conversion control being configured to perform state conversion on the sight; processing, in response to a trigger operation for a sight on control, the first scene picture according to a zoom magnification of the sight, to obtain a reference scene picture; and displaying a second game picture, the second game picture including the sight, the sight being in an on state, an internal picture of the sight being the reference scene picture, an external picture of the sight being obtained based on the first scene picture, and a size of an object included in the external picture of the sight being smaller than a size of an object included in the reference scene picture.

### RELATED APPLICATION

This application is a continuation application of PCT Application PCT/CN2024/072241, filed on Jan. 15, 2024, which claims priority to Chinese Patent Application No. 202310248919.1, filed on May 20, 2022, each entitled “GAME PICTURE DISPLAY METHOD AND APPARATUS, DEVICE, AND COMPUTER-READABLE STORAGE MEDIUM,” and each which is incorporated herein by reference in its entirety.

### FIELD OF THE TECHNOLOGY

Aspects described herein generally relate to the field of computer technologies, and in particular, to a game picture display method and apparatus, a device, and a computer-readable storage medium.

### BACKGROUND

With the continuous development of computer technologies, there are more and more types of games running on terminal devices such as smartphones. During the running of the games, a game picture display method is needed, so that game pictures are displayed on the terminal devices.

### SUMMARY

Aspects described herein generally relate to providing a game picture display method and apparatus, a device, and a computer-readable storage medium. The technical solutions include the following several aspects.

Aspects described herein may provide a game picture display method, the method being performed by a terminal device, and the method including:
displaying a first game picture, the first game picture including a first scene picture, a sight, and a conversion control, the sight being in an off state, and the conversion control being configured to perform state conversion on the sight;
processing, in response to a trigger operation for the conversion control, the first scene picture according to a zoom magnification of the sight, to obtain a reference scene picture; and
displaying a second game picture, the second game picture including the sight, the sight being in an on state, an internal picture of the sight including the reference scene picture, an external picture of the sight being obtained based on the first scene picture, and a size of an object included in the external picture of the sight being smaller than a size of an object included in the reference scene picture.

Aspects described herein may provide a game picture display method, the method being performed by a terminal device, and the method including:
displaying a first game picture, the first game picture including a first scene picture, a sight, and a conversion control, the sight being in an off state, and the conversion control being configured to perform state conversion on the sight; and
displaying a second game picture in response to a trigger operation for the conversion control, the second game picture including the sight, the sight being in an on state, an internal picture of the sight including a reference scene picture, a magnification of an object included in an external picture of the sight being less than a magnification of an object included in the reference scene picture, and the magnification of the object included in the reference scene picture being greater than a magnification of an object included in the first scene picture.

Aspects described herein may provide a game picture display apparatus, including:
a display module configured to display a first game picture, the first game picture including a first scene picture, a sight, and a conversion control, the sight being in an off state, and the conversion control being configured to perform state conversion on the sight; and
a processing module configured to process, in response to a trigger operation for the conversion control, the first scene picture according to a zoom magnification of the sight, to obtain a reference scene picture;
the display module being further configured to display a second game picture, the second game picture including the sight, the sight being in an on state, an internal picture of the sight including the reference scene picture, an external picture of the sight being obtained based on the first scene picture, and a size of an object included in the external picture of the sight being smaller than a size of an object included in the reference scene picture.

Aspects described herein may provide a game picture display apparatus, including:
a display module configured to display a first game picture, the first game picture including a first scene picture, a sight, and a conversion control, the sight being in an off state, and the conversion control being configured to perform state conversion on the sight;
the display module being further configured to display a second game picture in response to a trigger operation for the conversion control, the second game picture including the sight, the sight being in an on state, an internal picture of the sight including a reference scene picture, a magnification of an object included in an external picture of the sight being less than a magnification of an object included in the reference scene picture, and the magnification of the object included in the reference scene picture being greater than a magnification of an object included in the first scene picture

Aspects described herein may provide an electronic device, the electronic device including a processor and a memory, the memory storing at least one program code, and the at least one program code being loaded and executed by the processor, to cause the electronic device to implement any one of the foregoing the game picture display methods.

Aspects described herein may provide a non-transitory computer-readable storage medium, the non-transitory computer-readable storage medium including at least one program code, and the at least one program code being loaded and executed by a processor, to cause a computer to implement any one of the foregoing the game picture display methods.

Aspects described herein may provide a computer program or a computer program product, the computer program or the computer program product storing at least one computer instruction, and the at least one computer instruction being loaded and executed by a processor, to cause a computer to implement any one of the foregoing the game picture display methods.

According to the technical solution provided herein, after the trigger operation for the conversion control is received, the first scene picture is zoomed in, to obtain the reference scene picture, so that the size of the object included in the reference scene picture is larger than the size of the object included in the first scene picture. A second game picture is displayed, the internal picture of the sight in the second game picture is the reference scene picture, the external picture of the sight is determined based on the first scene picture, and the size of the object included in the internal picture of the sight is larger than the size of the object included in the external picture of the sight, so that zoom magnifications of the internal picture and the external picture of the sight are different, which achieves a difference between the inside and the outside of the sight and then improves a display effect of a game picture, thereby improving game experience of a game object. Moreover, the calculated amount of a scene picture is smaller, and there is a lower requirement for the performance of the terminal device displaying the game picture, which can save resources.

### BRIEF DESCRIPTION OF THE DRAWINGS

FIG. 1 is a schematic diagram of an example environment of a game picture display method.

FIG. 2 is a flowchart of an example game picture display method.

FIG. 3 is a schematic diagram of an example display of a first game picture.

FIG. 4 is a schematic diagram of an example display of a third scene picture.

FIG. 5 is a schematic diagram of an example acquisition of a third scene picture.

FIG. 6 is a schematic diagram of an example acquisition of a fourth scene picture.

FIG. 7 is a schematic diagram of an example acquisition of a reference scene picture.

FIG. 8 is a schematic diagram of an example acquisition of a reference scene picture.

FIG. 9 is a schematic diagram of an example display of a second game picture.

FIG. 10 is a schematic diagram of an example display of another second game picture.

FIG. 11 is a flowchart of an example game picture display method.

FIG. 12 is a flowchart of an example method for acquiring a reference scene picture.

FIG. 13 is a schematic structural diagram of an example game picture display apparatus.

FIG. 14 is a schematic structural diagram of an example game picture display apparatus.

FIG. 15 is a schematic structural diagram of an example terminal device.

FIG. 16 is a schematic structural diagram of an example server.

### DETAILED DESCRIPTION

The technical solutions will be described below clearly and comprehensively in conjunction with accompanying drawings of the examples described in this application. The terms “first,” “second,” and so on in this application are intended to distinguish similar objects but do not necessarily indicate a specific order or sequence. Such used data is interchangeable where appropriate so that the examples described here can be implemented in an order other than those illustrated or described here. Examples described in the following exemplary aspects do not represent all implementations that are consistent with this application. Instead, they are merely examples of the apparatus and method consistent with some aspects.

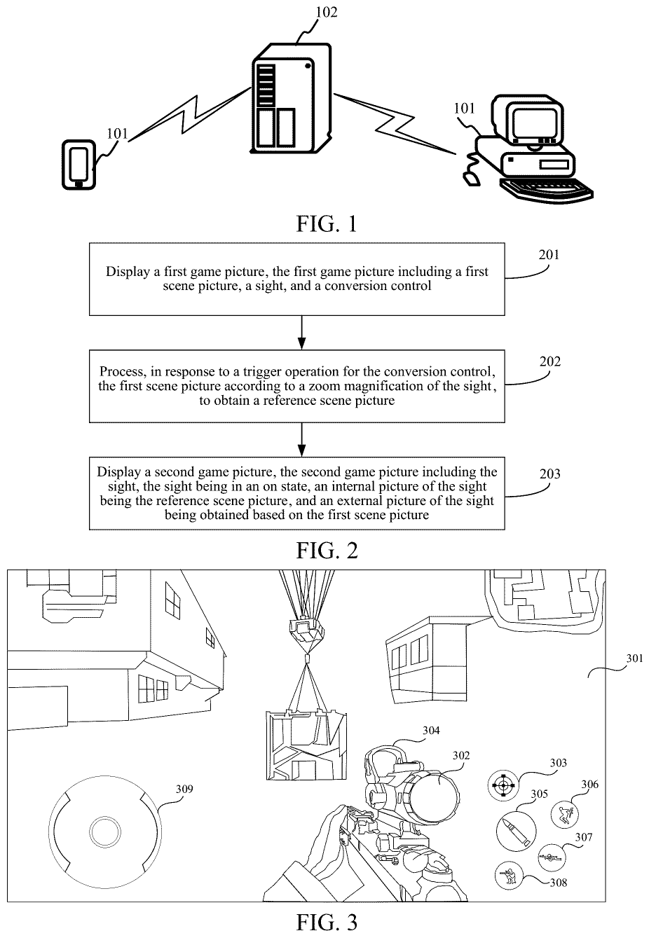

FIG. 1 is a schematic diagram of an example implementation environment of a game picture display method. As shown in FIG. 1, the implementation environment may include: a terminal device 101 and a server 102.

An application program that can provide a game picture may be installed and run in the terminal device 101. The terminal device 101 may be configured to perform the game picture display method.

A type of the application program that can provide the game picture is not limited. For example, the application program that can provide the game picture may be a game application program, such as a third-person shooting (TPS) game, a first-person shooting (FPS) game, a multiplayer online battle arena (MOBA) game, a multiplayer shooting survival game, and a massive multiplayer online role-playing game (MMO). In an example, the game application program may be a game application program based on frame synchronization. That is, the game picture display method may be applicable to the game application program based on frame synchronization.

Certainly, in addition to the game application program, the application program that can provide the game picture may also be an application program of another type, for example, a virtual reality (VR) application program, an augmented reality (AR) application program, a three-dimensional map program, a map simulation program, a social application program, or an interactive entertainment application program.

The server 102 may be configured to provide a backend service for the application program that can provide the game picture and may be installed in the terminal device 101. In some aspects, the server 102 may take on primary computing work, and the terminal device 101 may take on secondary computing work. Alternatively, the server 102 may take on the secondary computing work, and the terminal 101 may take on the primary computing work. Alternatively, collaborative computing may be performed between the server 102 and the terminal device 101 by using a distributed computing architecture.

In some examples, the terminal device 101 may be any electronic product that may perform human-computer interaction with a user in one or more manners, such as a keyboard, a touchpad, a touchscreen, a remote control, voice interaction, or a handwriting device, for example, a personal computer (PC), a mobile phone, a smartphone, a personal digital assistant (PDA), a wearable device, a pocket PC (PPC), a tablet computer, a smart on-board unit, a smart television, or a smart speaker.

The server 102 may be one server, a server cluster including a plurality of server units, or a cloud computing service center. The server 102 and the terminal device 101 may be directly or indirectly connected in a wired or wireless communication manner.

The terminal device 101 and the server 102 are only examples, and other existing or future possible terminal devices or servers that are applicable to this application may also be included.

Aspects described herein may provide a game picture display method applicable to the foregoing implementation environment. By taking a flowchart of a game picture display method shown in FIG. 2 as an example, the method may be performed by the terminal device 101 in FIG. 1. As shown in FIG. 2, the method may include the following operation 201 to operation 203.

Operation 201: Display a first game picture, the first game picture including a first scene picture, a sight, and a conversion control.

In an example, a target game that can provide a game picture may be installed and run on a terminal device. The target game may be a game of any type. For example, the target game may be an MOBA game.

In an example, related information of multiple application programs may be displayed on a display interface of the terminal device. Types of the application programs may be the same or different. The related information of the application programs may be icons of the application programs or names of the application programs. In response to related information of a target game in multiple application programs that is selected by the user and displayed, the terminal device may receive a selection instruction for the related information of the target game, run the target game, and then display a page of the target game. A game start control may be displayed on the page, and the game start control may be configured to enter the target game.

When the user wants to enter the target game, the user may select the game start control. In this case, the terminal device may receive the selection instruction for the game start control, and display a first game picture. The first game picture may include a first scene picture, a sight, and a conversion control. The sight may be in an off state. The conversion control may be configured to perform state conversion on the sight, or the conversion control may be configured to convert a state of the sight. The state of the sight may include, but may be not limited to, an off state and an on state. The conversion control may be configured to convert between the off state and the on state. For example, the conversion control may be configured to convert the state of the sight into the on state when the sight may be in the off state. The conversion control may be further configured to convert the state of the sight into the off state when the sight may be in the on state. For example, the conversion control may be an independent control. Alternatively, the conversion control may include a sight on control and a sight off control. The sight on control may be configured to convert the state of the sight into the on state when the sight may be in the off state, or the sight on control may be configured to turn on the sight. The sight off control may be configured to convert the state of the sight into the off state when the sight may be in the on state. For example, the first game picture may include the sight on control. The sight may be an independent item, or may be a sight included in a virtual item. In some examples, the virtual item may be a tool of any type. The virtual item may be used by a target object, and the target object may be an object controlled by the user. In some examples, the conversion control may be displayed in a second form. The second form may be configured to indicate that the sight included in the first game picture may be in an off state. For example, “the conversion control may be displayed in a second form” means that the conversion control may be displayed in white.

FIG. 3 is a schematic diagram of an example display of a first game picture. A first scene picture 301, a sight 302, and a conversion control 303 may be displayed. The sight 302 may be a sight included in a virtual item 304, and the sight may be in an off state.

In some examples, the first game picture further includes a transmit control 305, a jump control 306, a lay-down control 307, a squat control 308, and a direction control 309. The transmit control 305 may be configured to transmit a virtual resource by using a virtual item, the jump control 306 may be configured to instruct the target object to jump, the lay-down control 307 may be configured to instruct the target object to lay down, the squat control 308 may be configured to instruct the target object to squat, and the direction control 309 may be configured to determine a direction of travel of the target object. Certainly, other content may also be displayed in the first game picture.

Operation 202: Process, in response to a trigger operation for the conversion control, the first scene picture according to a zoom magnification of the sight, to obtain a reference scene picture.

For example, a size of an object included in the reference scene picture may be larger than a size of an object included in the first scene picture. In some examples, a second scene picture that may be in the first scene picture and correspond to the sight may be processed. The second scene picture may belong to part of a first scene. A size of an object included in the second scene picture may be the same as the size of the object included in the first scene picture, so that the size of the object included in the reference scene picture may also be larger than the size of the object included in the second scene picture. Since only the second scene picture that may be in the first scene picture and correspond to the sight needs to be processed, a calculation amount of a scene picture may be smaller, and there may be a lower requirement for the performance of the terminal device displaying the game picture, which can save resources.

For example, a zoom magnification of the reference scene picture relative to the first scene picture may be determined based on the zoom magnification of the sight. In some implementations, the zoom magnification of the sight may be the zoom magnification of the reference scene picture relative to the first scene picture, or the zoom magnification of the sight may be the same as the zoom magnification of the reference scene picture relative to the first scene picture. In some other implementations, the zoom magnification of the sight may be corrected according to an actual requirement to obtain a corrected zoom magnification. The corrected zoom magnification may be the zoom magnification of the reference scene picture relative to the first scene picture. For example, the zoom magnification may be corrected according to a screen size of the terminal device, so that the reference scene picture has a good display effect on the terminal device having the screen size.

When the user wants to turn on the sight, the user may select the conversion control, and the terminal device receives a trigger operation for the conversion control. A manner in which the user selects the conversion control may not be limited to the aspects described herein. In some examples, the manner in which the user selects the conversion control may be that the user clicks the conversion control or maybe that the conversion control may be selected by voice.

In some examples, a process of processing, according to the zoom magnification of the sight, a second scene picture that may be in the first scene picture and corresponds to the sight, to obtain the reference scene picture includes, but may not be limited to, the following three processes.

In the first manner, the reference scene picture may be acquired by: adjusting the first scene picture to obtain a third scene picture; and processing, according to the zoom magnification of the sight, a fourth scene picture that may be in the third scene picture and corresponds to the sight, to obtain the reference scene picture.

A size of an object included in the third scene picture may be larger than the size of the object included in the first scene picture, and a field of view range of the third scene picture may be smaller than a field of view range of the first scene picture. The size of the object included in the reference scene picture may be larger than a size of an object included in the fourth scene picture. A size of the reference scene picture may be the same as a size of the sight. For example, “a size of the reference scene picture may be the same as a size of the sight” includes: the size of the reference scene picture being the same as a size of the internal picture of the sight that may be turned on (or the sight in the on state).

A manner of adjusting the first scene picture to obtain the third scene picture may not be limited to the aspects described herein. In some examples, at least two following implementation manners of adjusting the first scene picture to obtain the third scene picture may be provided.

In the first implementation manner, a first field of view corresponding to the first scene picture and a zoom magnification of the sight may be acquired, and the first scene picture may be adjusted according to the first field of view and the zoom magnification of the sight, to obtain the third scene picture.

The first field of view corresponding to the first scene picture may be a field of view set by a developer of the target game when the target game is developed. In some examples, the first field of view corresponding to the first scene picture may be stored in a storage space of the terminal device, and the terminal device acquires the first field of view corresponding to the first scene picture from the storage space of the terminal device. Alternatively, a corresponding relationship between game identifiers and game field of views may be stored in the server, and the terminal device and the server perform communication connection through a wired network or a wireless network. The terminal device may transmit a first acquisition request to the server. The first acquisition request may include a game identifier of a target game. The server may receive the first acquisition request and parse the first acquisition request, to obtain the game identifier of the target game; and determine a field of view corresponding to the target game according to the game identifier of the target game and the corresponding relationship between the game identifiers and game the field of views, wherein the field of view corresponding to the target game may be a first field of view. The server may transmit the first field of view to the terminal device so that the terminal device acquires the first field of view.

When the sight is a sight included in a virtual item, the zoom magnification of the sight may correspond to the virtual item. In some examples, a first corresponding relationship between item identifiers and zoom magnifications may be stored in the terminal device. In the first corresponding relationship, the item identifiers are item identifiers of virtual items, and the zoom magnifications are zoom magnifications of sights included in the virtual items. The terminal device may query the first corresponding relationship according to an item identifier of a virtual item (e.g., a virtual item used by a target user) to obtain a zoom magnification of a sight included in the virtual item. Alternatively, the first corresponding relationship may be stored in the server. The terminal device may transmit a second acquisition request to the server. The second acquisition request may include an item identifier of a virtual item. The server may receive the second acquisition request and parse the second acquisition request to obtain the item identifier of the virtual item. The server may query the first corresponding relationship according to the item identifier of the virtual item to obtain a zoom magnification of a sight included in the virtual item. The server may transmit the zoom magnification of the sight to the terminal device, so that the terminal device acquires the zoom magnification of the sight.

When the sight may be an independent item, the sight and the zoom magnification of the sight are in one-to-one correspondence. That is, there may be a second corresponding relationship between identifiers of sights and zoom magnifications of the sights. The terminal device queries the second corresponding relationship according to an identifier of a sight (e.g., a sight used by a target object) to obtain a zoom magnification of the sight. Alternatively, the server may determine the zoom magnification of the sight and transmit the zoom magnification of the sight to the terminal device so that the terminal device acquires the zoom magnification of the sight. The process may be similar to the foregoing process of acquiring the zoom magnification of the sight when the sight may be attached to the virtual item, that is when the virtual item includes the sight. Details are not described herein again.

In a possible implementation, a process of adjusting the first scene picture according to the first field of view and the zoom magnification of the sight to obtain the third scene picture includes: determining a second field of view according to the first field of view and the zoom magnification of the sight; and adjusting the first scene picture according to the second field of view, to obtain the third scene picture. For example, the second field of view may be a field of view corresponding to a target zoom magnification corresponding to the zoom magnification of the sight.

A process of determining the second field of view according to the first field of view and the zoom magnification of the sight includes: determining the target zoom magnification corresponding to the zoom magnification of the sight; and determining the second field of view according to the first field of view and the target zoom magnification. The target zoom magnification may be a zoom magnification of the third scene picture relative to the first scene picture.

In some examples, a third corresponding relationship between zoom magnifications of sights and target zoom magnifications may be stored in the terminal device. The terminal device queries the third corresponding relationship according to the zoom magnification of the sight to obtain a target zoom magnification corresponding to the zoom magnification of the sight. Table 1 below is an exemplary table of the third corresponding relationship. The table may be merely an example, and a form of the third corresponding relationship may be not limited to the table.

TABLE 1

| | Target zoom |
|---|---|
| | magnifications |
| | corresponding |
| Zoom | to the zoom |
| magnifications | magnifications |
| of sights | of the sights |
| 3X | 2.7X |
| 4X | 3.6X |
| 6X | 5.2X |
| 7X | 5.8X |
| 16X | 12.9X |
| 20X | 16X |

As can be seen from Table 1 above, when the zoom magnification of the sight may be 3×, the target zoom magnification corresponding to the zoom magnification of the sight may be 2.7×. When the zoom magnification of the sight may be 4×, the target zoom magnification corresponding to the zoom magnification of the sight may be 3.6×. When the zoom magnifications of the sights are other magnifications other than 3× and 4×, the target zoom magnifications corresponding to the zoom magnifications of the sights are as shown in Table 1 above, and details are not described herein again.

Alternatively, the third corresponding relationship may be stored in the server. The terminal device transmits a third acquisition request to the server. The third acquisition request includes a zoom magnification of a sight. The server receives the third acquisition request and parses the third acquisition request, to obtain the zoom magnification of the sight. The server queries the third corresponding relationship according to the zoom magnification of the sight to obtain a target zoom magnification corresponding to the zoom magnification of the sight. The server transmits the determined target zoom magnification to the terminal device so that the terminal device acquires the target zoom magnification corresponding to the zoom magnification of the sight.

In some examples, after the target zoom magnification corresponding to the zoom magnification of the sight may be determined, a process of determining the second field of view according to the first field of view and the target zoom magnification includes: determining a reference value according to the first field of view; determining a target value according to the reference value and the target zoom magnification; and determining the second field of view according to the target value. For example, a tangent value of one-half of the first field of view may be taken as the reference value, and a quotient between the target zoom magnification and the reference value (e.g., a quotient obtained by dividing the reference value by the target zoom magnification) may be taken as the target value. Twice an arctangent value of the target value may be taken as the second field of view.

In some examples, the second field of view may be determined according to the first field of view and the target zoom magnification based on the following Formula (1).

$$tan \frac{FOV 2}{2} = \frac{tan \frac{FOV 1}{2}}{A} \qquad Formula ( 1 )$$

In the foregoing Formula (1), FOV2 denotes the second field of view, FOV1 denotes the first field of view, and A denotes the target zoom magnification.

For example, the first field of view may be 75 degrees, the target zoom magnification may be 3.6, and it may be determined, according to the foregoing Formula (1), that the second field of view may be 23.966 degrees.

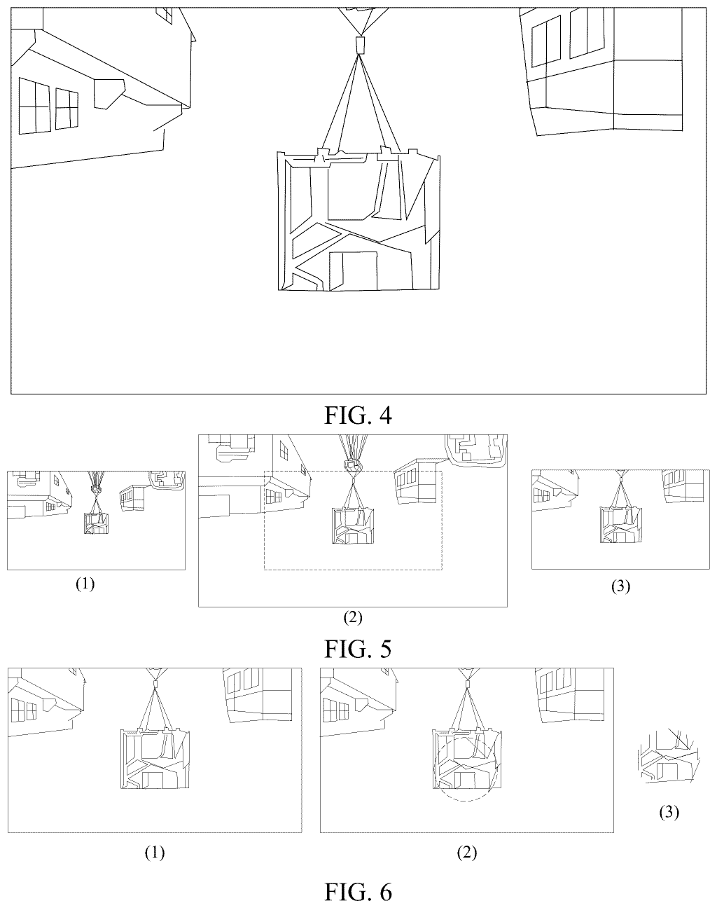

In a possible implementation, after the second field of view may be determined, content included in the first scene picture may be rendered according to the second field of view, to obtain the third scene picture. FIG. 4 is a schematic diagram of a display of a third scene picture. As can be seen from FIG. 4 and FIG. 3, a size of an object included in FIG. 4 may be larger than a size of an object included in FIG. 3, and a field of view in FIG. 4 may be smaller than a field of view in FIG. 3.

In the second implementation manner, the target zoom magnification corresponding to the zoom magnification of the sight may be determined; the first scene picture may be stretched according to the target zoom magnification to obtain a second target scene picture; and the second target scene picture may be clipped, to obtain the third scene picture. The target zoom magnification may be a zoom magnification of the third scene picture relative to the first scene picture.

The process of determining the target zoom magnification corresponding to the zoom magnification of the sight has been described in the first implementation manner above, and details are not described herein again. A size of the second target scene picture may be target zoom magnification times a size of the first scene picture. For example, if the target zoom magnification may be 3.6, the size of the second target scene picture may be 3.6 times the size of the first scene picture. Clipping may be performed by taking a center point of the second target scene picture as a center, to obtain the third scene picture. A center point of the third scene picture may be the center point of the second target scene picture. For example, a size of the third scene picture may be the same as or different from the size of the first scene picture. However, a size of an object included in the third scene picture may be larger than the size of the object included in the first scene picture. For example, the object included in the third scene picture may be of a first size, the object included in the first scene picture may be of a second size, and the first size may be target zoom magnification times the second size.

In a possible implementation, a process of clipping the second target scene picture to obtain the third scene picture includes: determining a candidate region by taking the center point of the second target scene picture as a center, where a length of the candidate region may be a length of the first scene picture, a width of the candidate region may be a width of the first scene picture, and a center point of the candidate region may be the center point of the second target scene picture, and taking a scene picture covered by the candidate region in the second target scene picture as the third scene picture.

FIG. 5 is a schematic diagram of the acquisition of a third scene picture. (1) in FIG. 5 may be the first scene picture, (2) in FIG. 5 may be the second target scene picture, a region included by a dotted line in (2) may be the candidate region, and (3) in FIG. 5 may be the third scene picture.

The third scene picture may be acquired in the first implementation manner above, or the third scene picture may be acquired in the second implementation manner above.

In some examples, after the third scene picture may be acquired, a fourth scene picture that may be in the third scene picture and corresponds to the sight may be processed according to the zoom magnification of the sight, to obtain the reference scene picture. Before the fourth scene picture may be processed, the fourth scene picture needs to be acquired first. For example, when the fourth scene picture needing to be acquired may be in the shape of a circle, a process of acquiring the fourth scene picture includes: determining a reference region by taking the center point of the third scene picture as a center and a target length as a radius; and taking a scene picture covered by the reference region in the third scene picture as the fourth scene picture. The target length may be a radius of the sight. Alternatively, when the fourth scene picture needing to be acquired may be in another shape other than the circle, the process of acquiring the fourth scene picture includes: taking the center point of the third scene picture as a center, determining a region with a reference size, and taking a scene picture covered by the region with the reference size in the third scene picture as the fourth scene picture. The reference size may be a size of the internal picture of the sight.

FIG. 6 may be a schematic diagram of the acquisition of a fourth scene picture. For example, the fourth scene picture may be in the shape of a circle. (1) in FIG. 6 may be the third scene picture, a region included by a dotted line in (2) in FIG. 6 may be the reference region, and (3) in FIG. 6 may be the fourth scene picture.

In a possible implementation, after the fourth scene picture may be acquired, the fourth scene picture may be processed according to the zoom magnification of the sight, to obtain the reference scene picture. Two processing manners of processing the fourth scene picture according to the zoom magnification of the sight, to obtain the reference scene picture are provided.

In the first processing manner, a reference zoom magnification may be determined according to the zoom magnification of the sight; first image coordinates of a center point of the sight and second image coordinates of pixels in the fourth scene picture are acquired; and pixel information of the pixels may be adjusted according to the reference zoom magnification, the first image coordinates, and the second image coordinates of the pixels, to obtain the reference scene picture.

The reference zoom magnification may be a zoom magnification of the reference scene picture relative to the fourth scene picture. A process of determining the zoom magnification of the sight has been described in the first implementation manner above, and details are not described herein again.

In some examples, a process of determining the reference zoom magnification according to the zoom magnification of the sight includes: determining a target zoom magnification corresponding to the zoom magnification of the sight; and determining the reference zoom magnification according to the zoom magnification of the sight and the target zoom magnification. For example, a quotient between the zoom magnification of the sight and the target zoom magnification (e.g., a quotient obtained by dividing the zoom magnification of the sight by the target zoom magnification) may be taken as the reference zoom magnification. The process of determining the target zoom magnification has also been described in operation 202 above, and details are not described herein again.

For example, when the zoom magnification of the sight may be 4×, and the target zoom magnification corresponding to the zoom magnification of the sight may be 3.6×, the reference zoom magnification may be 4/3.6.

In a possible implementation, a process of acquiring the first image coordinates of the center point of the sight includes: acquiring coordinates of the center point of the sight in a world coordinate system; and converting the coordinates of the center point of the sight in the world coordinate system according to a transformation matrix, to obtain the first image coordinates of the center point of the sight.

In some examples, a process of adjusting the pixel information of the pixels according to the reference zoom magnification, the first image coordinates, and the second image coordinates of the pixels to obtain the reference scene picture includes: determining, according to the reference zoom magnification, the first image coordinates, and the second image coordinates of the pixels, third image coordinates after the pixels are offset; and for any pixel in the pixels, adjusting, based on the existence of a reference pixel that may be in the pixels and whose third image coordinates are the same as those after the pixel may be offset, pixel information of the reference pixel to pixel information of any pixel, and traversing the pixels, to obtain the reference scene picture. The pixel information includes, but may be not limited to, at least one of color information and transparency information of the pixel. The color information of the pixel includes a red value, a green value, and a blue value of the pixel.

A process of determining, according to the reference zoom magnification, the first image coordinates, and the second image coordinates of the pixels, third image coordinates after the pixels are offset includes: determining, for any pixel in the pixels, a target offset vector of the any pixel according to the reference zoom magnification, the first image coordinates, and the second image coordinates of the any pixel, the target offset vector of the any pixel being configured for indicating an offset between the second image coordinates of the any pixel and image coordinates of the any pixel that are zoomed in according to the reference zoom magnification, and the target offset vector of the any pixel including a first offset value of the any pixel in a first direction and a second offset value of the any pixel in a second direction; and determining, according to the second image coordinate of the any pixel, the first offset value of the any pixel in the first direction, and the second offset value of the any pixel in the second direction, the third image coordinates after the any pixel may be offset.

In some examples, a process of determining the target offset vector of the any pixel according to the reference zoom magnification, the first image coordinates, and the second image coordinates of the any pixel includes: determining a reference offset vector of the any pixel according to the reference zoom magnification, the first image coordinates, and the second image coordinates of the any pixel; and taking the reference offset vector of the any pixel as the target offset vector of the any pixel, or determining the target offset vector of the any pixel according to the reference offset vector of the any pixel.

In a possible implementation, the reference offset vector of the any pixel may be determined according to the reference zoom magnification, the first image coordinates, and the second image coordinates of the any pixel based on the following Formula (2).

$$P = ( 1 - \frac{1}{B} ) * ( U - V ) \qquad Formula ( 2 )$$

In the foregoing Formula (2), P denotes the reference offset vector of the any pixel, B denotes the reference zoom magnification, U denotes the first image coordinates, and V denotes the second image coordinates of the any pixel.

For example, the reference zoom magnification may be 4/3.6, the first image coordinates are (10, 10), the second image coordinates of any pixel are (6, 4), and it may be determined according to the foregoing Formula (2) that the reference offset vector of the any pixel may be (0.4, 0.6).

The target offset vector of the any pixel may be determined according to the reference offset vector of the any pixel in the following two manners.

In the first manner, an encoded intermediate vector of the any pixel may be determined according to the reference offset vector of the any pixel; and a target offset vector of the any pixel may be determined according to the encoded intermediate vector of the any pixel.

The encoded intermediate vector may be a vector obtained after normalization of the reference offset vector. In some examples, the encoded intermediate vector of the any pixel may be determined according to the reference offset vector of the any pixel based on the following Formula (3).

$$Q = ( P + float 2 ( 1. \text{.1} \text{.0} ) ) * 0.5 \qquad Formula ( 3 )$$

In the foregoing formula (3), Q denotes the encoded intermediate vector of the any pixel, P denotes the reference offset vector of the any pixel, and float denotes a floating-point function.

The encoded intermediate vector of the any pixel includes a third offset value of the any pixel in the first direction and a fourth offset value of the any pixel in the second direction, and a process of determining the target offset vector of the any pixel according to the encoded intermediate vector of the any pixel includes: determining the target offset vector of the any pixel according to the third offset value and the fourth offset value.

In some examples, a process of determining the target offset vector of the any pixel according to the third offset value and the fourth offset value includes: encoding the third offset value to obtain a first binary value, and encoding the fourth offset value to obtain a second binary value; acquiring a third binary value and a fourth binary value according to the first binary value, and acquiring a fifth binary value and a sixth binary value according to the second binary value; and determining the target offset vector of the any pixel according to the third binary value, the fourth binary value, the fifth binary value, and the sixth binary value.

The first binary value and the second binary value have the same quantity of bits. For example, both the first binary value and the second binary value have 16 bits. The third binary value and the fourth binary value may have the same quantity of or different quantities of bits, and the fifth binary value and the sixth binary value may have the same quantity of or different quantities of bits.

In some examples, a process of acquiring the third binary value and the fourth binary value according to the first binary value includes: splitting the first binary value to obtain the third binary value and the fourth binary value. For example, the first binary value has 16 bits, the first eight bits of the first binary value are taken as the third binary value, and the last eight bits of the first binary value are taken as the fourth binary value.

For example, according to the first binary value, the third binary value may be acquired according to the following Formula (4), and the fourth binary value may be acquired according to the following Formula (5).

$$L = frac ( M ) - frac ( M * 255. f ) / 255. f \qquad Formula ( 4 )$$

$$K = frac ( N * 255. f ) \qquad Formula ( 5 )$$

In the foregoing formula (4), L denotes the third binary value, M denotes the first S digits of the first binary value, frac denotes a function, and S may be set based on experience or adjusted according to an implementation environment. S may be greater than zero and may be less than the quantity of bits included in the first binary value, and 255.0f denotes a maximum value that an eight-bit binary value can express. In the foregoing formula (5), K denotes the fourth binary value, and N denotes a digit other than the first S digits in the first binary value.

A process of acquiring the fifth binary value and the sixth binary value according to the second binary value includes: splitting the second binary value to obtain the fifth binary value and the sixth binary value. For example, the second binary value has 16 bits, the first eight bits of the second binary value are taken as the fifth binary value, and the last eight bits of the second binary value are taken as the sixth binary value. In some examples, according to the second binary value, the fifth binary value may be acquired according to the foregoing Formula (4), and the sixth binary value may be acquired according to the foregoing Formula (5).

In a possible implementation, a process of determining the target offset vector of the any pixel according to the third binary value, the fourth binary value, the fifth binary value, and the sixth binary value includes: decoding the third binary value to obtain a first value, decoding the fourth binary value to obtain a second value, decoding the fifth binary value to obtain a third value, and decoding the sixth binary value to obtain a fourth value; and determining the target offset vector of the any pixel according to the first value, the second value, the third value, and the fourth value.

For example, a decimal value corresponding to the third binary value may be taken as the first value. A decimal value corresponding to the fourth binary value may be taken as the second value. A decimal value corresponding to the fifth binary value may be taken as the third value. A decimal value corresponding to the sixth binary value may be taken as the fourth value.

In a possible implementation, a process of determining the target offset vector of the any pixel according to the first value, the second value, the third value, and the fourth value includes: determining first coordinates according to the first value and the second value, a value of the first coordinates in the first direction being the first value, and a value of the first coordinates in the second direction being the second value; determining second coordinates according to the third value and the fourth value, a value of the second coordinates in the first direction being the third value, and a value of the second coordinates in the second direction being the fourth value; and determining the target offset vector of the any pixel according to the first coordinates and the second coordinates.

For example, the target offset vector of the any pixel may be determined according to the first value, the second value, the third value, and the fourth value based on the following Formula (6).

$$W = ( M - \frac{N}{255. f} ) + 2. - 1 \qquad Formula ( 6 )$$

In the foregoing formula (6), W denotes the target offset vector of the any pixel, M denotes the first coordinates, and N denotes the second coordinates.

In the second manner, the reference offset vector of the any pixel includes a fifth offset value of the any pixel in the first direction and a sixth offset value in the second direction, and the target offset vector of the any pixel may be determined according to the fifth offset value and the sixth offset value.

A process of determining the target offset vector of the any pixel according to the fifth offset value and the sixth offset value may be similar to the process of determining the target offset vector of the any pixel according to the third offset value and the fourth offset value in the first manner above, and details are not described herein again.

The target offset vector of the any pixel may be determined by selecting the first manner, or the target offset vector of the any pixel may be determined by selecting the second manner.

After the reference offset vector of the pixel is acquired, the reference offset vector of the pixel needs to be stored in a render target (RT). Due to the limited storage capacity of the RT, a two-channel reference offset vector needs to be adjusted to a four-channel value; the four-channel value may be stored in the RT, the four-channel value may be acquired from the RT, the four-channel value may be processed to obtain a two-channel target offset vector, and the second image coordinates of the pixel are adjusted according to the target offset vector, to obtain the third image coordinates after the pixel may be offset.

In the second processing manner, a reference zoom magnification may be determined according to the zoom magnification of the sight; the fourth scene picture may be stretched according to the reference zoom magnification to obtain a first target scene picture; and the first target scene picture may be clipped, to obtain the reference scene picture.

The reference zoom magnification may be a zoom magnification of the reference scene picture relative to the fourth scene picture. A size of the first target scene picture may be reference zoom magnification times a size of the fourth scene picture. A center point of the reference scene picture may be a center point of the first target scene picture, and a size of the reference scene picture may be the same as a size of the sight. For example, “a size of the reference scene picture may be the same as a size of the sight” includes: The size of the reference scene picture may be the same as a size of the internal picture of the sight. The internal picture of the sight may be a picture displayed after the sight is turned on (or the sight in the on state).

The process of acquiring the zoom magnification of the sight and the process of determining the reference zoom magnification according to the zoom magnification of the sight has been described in the first processing manner above, and details are not described herein again.

In a possible implementation, for example, a process of clipping, when the reference scene picture may be in the shape of a circle, the first target scene picture to obtain the reference scene picture includes: determining a target region by taking the center point of the first target scene picture as a center and a target length as a radius, and taking a scene picture covered by the target region in the first target scene picture as the reference scene picture. The target length may be a radius of the sight. Alternatively, when the reference scene picture may be in another shape other than the circle, the process of acquiring the reference scene picture includes: taking the center point of the first target scene picture as a center, determining a region with a reference size, and taking a scene picture covered by the region with the reference size in the first target scene picture as the reference scene picture. The reference size may be a size of the internal picture of the sight.

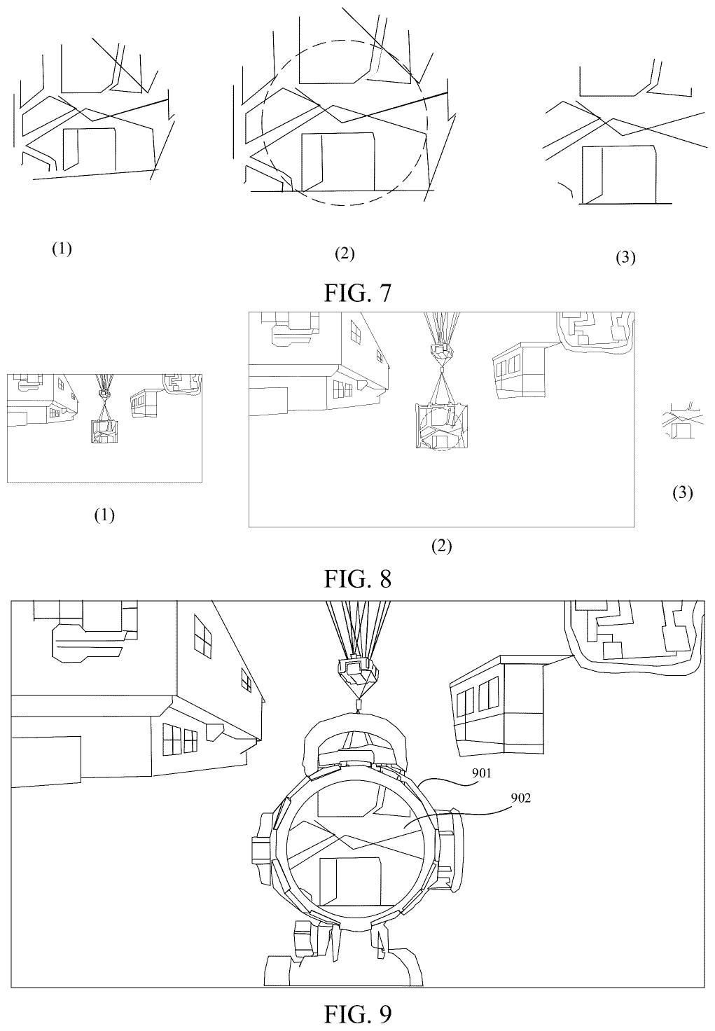

FIG. 7 may be a schematic diagram of the acquisition of a reference scene picture. For example, the reference scene picture may be in the shape of a circle. (1) in FIG. 7 may be the fourth scene picture, (2) in FIG. 7 may be the first target scene picture, a region included by a dotted line in (2) may be the target region, and (3) in FIG. 7 may be the reference scene picture.

The reference scene picture may be acquired in the first manner of acquiring the reference scene picture. There may be a smaller difference between a size of an object included in the reference scene picture and a size of an object included in the third scene picture. When the reference scene picture may be subsequently displayed inside the sight, and a scene picture other than the fourth scene picture in the third scene picture may be displayed outside the sight, there may be a difference between the size of the internal picture of the sight and the size of the external picture of the sight, thereby achieving a difference between the inside and the outside of the sight. The size of the object included in the external picture of the sight may be larger than the size of the object included in the first scene picture. Therefore, the difference between the internal picture and the external picture of the sight may not be large, and a blind region of the game picture may be smaller after the sight is turned on. The blind region refers to a region that the game object cannot see in the displayed game picture. The first scene picture may be zoomed in to obtain the third scene picture, and then the fourth scene picture that may be in the third scene picture and corresponds to the sight may be zoomed in to obtain the reference scene picture so that a transitional zoom magnification (that is, a zoom magnification of the third scene picture relative to the first scene picture) may be introduced into the process of acquiring the reference scene picture, and there may be a smaller difference between definitions of the internal picture and the external picture. Compared with the manner of displaying a scene picture other than the second scene picture in the first scene picture outside the sight, the manner of displaying the scene picture other than the fourth scene picture in the third scene picture outside the sight has a smaller magnification difference between the internal picture and the external picture of the sight, so that the internal picture of the sight may be displayed more clearly.

In addition, after the first scene picture is processed to obtain the third scene picture, the first scene picture may not be further processed, but a fourth scene picture that may be in the third scene picture and corresponds to the sight may be processed. The fourth scene picture is, for example, part of the third scene picture. Consequently, fewer scene pictures need to be processed. For example, the first scene picture does not need to be processed twice or more, thereby saving hardware and computing resources of the terminal device displaying the game picture and increasing the display speed of the game picture.

For example, when the internal picture (the reference scene picture) of the sight may be 20 times the first scene picture, and the external picture (the scene picture other than the second scene picture in the first scene picture) of the sight may be 1 time the first scene picture, due to a larger magnification difference between the internal picture and the external picture, a difference between definitions of the internal picture and the external picture may be larger, and the displayed internal picture may be more blurry. When the internal picture (the reference scene picture) of the sight may be 20 times the first scene picture, and the external picture of the sight (the scene picture other than the fourth scene picture in the third scene picture) may be 16 times the first scene picture, due to a smaller magnification difference between the internal picture and the external picture, the difference between definitions of the internal picture and the external picture may be smaller, and the displayed internal picture may be clearer.

In the second manner, the reference scene picture may be acquired by: adjusting pixel information of pixels in the second scene picture according to the zoom magnification of the sight, first image coordinates of a center point of the sight, and fourth image coordinates of the pixels in the second scene picture, to obtain the reference scene picture, where the second scene picture may be a picture that may be in the first scene picture and corresponds to the sight.

An implementation process of the second manner of acquiring the reference scene picture may be similar to the implementation process of the first processing manner above, and details are not described herein again.

In the third manner, the reference scene picture may be acquired by: stretching the second scene picture according to the zoom magnification of the sight to obtain a third target scene picture, and clipping the third target scene picture to obtain the reference scene picture, where the second scene picture may be a picture that may be in the first scene picture and corresponds to the sight.

A size of the third target scene picture may be zoom magnification times a size of the second scene picture, a center point of the reference scene picture may be a center point of the third target scene picture, and a size of the reference scene picture may be the same as a size of the sight.

An implementation process of the third manner of acquiring the reference scene picture may be similar to the implementation process of the second processing manner above, and details are not described herein again.

FIG. 8 may be a schematic diagram of the acquisition of a reference scene picture. (1) in FIG. 8 may be the first scene picture, (2) in FIG. 8 may be the third target scene picture, and (3) in FIG. 8 may be the reference scene picture.

When the reference scene picture may be acquired in the second manner of acquiring the reference scene picture and the third manner of acquiring the reference scene picture, the second scene picture needs to be acquired first. The process of acquiring the second scene picture may be similar to the process of acquiring the fourth scene picture in the above process, and details are not described herein again.

There may be a difference between a size of an object included in the reference scene picture acquired in the second manner of acquiring the reference scene picture or the third manner of acquiring the reference scene picture and a size of an object included in the first scene picture, so that when the reference scene picture may be subsequently displayed inside the sight. A scene picture other than the second scene picture in the first scene picture may be displayed outside the sight, a difference between the inside and the outside of the sight may be achieved. In addition, only the second scene picture that may be in the first scene picture and corresponds to the sight may be processed (or the complete first scene picture does not need to be processed), which saves hardware and computing resources of the terminal device displaying the game picture, and increases a display speed of the game picture.

Operation 203: Display a second game picture, the second game picture including the sight, the sight being in an on state, an internal picture of the sight being the reference scene picture, and an external picture of the sight being obtained based on the first scene picture.

A size of an object included in the external picture of the sight may be smaller than a size of an object included in the reference scene picture, that is, the size of the object included in the external picture of the sight may be smaller than a size of an object included in the internal picture of the sight.

In a possible implementation, when the reference scene picture may be acquired in the second manner of acquiring the reference scene picture or the third manner of acquiring the reference scene picture, the external picture of the sight may be a picture other than the second scene picture in the first scene picture. FIG. 9 may be a schematic diagram of display of a second game picture. A sight 901 may be displayed in the second game picture, the sight 901 may be in an on state, an internal picture of the sight may be a reference scene picture 902, and an external picture of the sight may be a picture other than the second scene picture in the first scene picture.

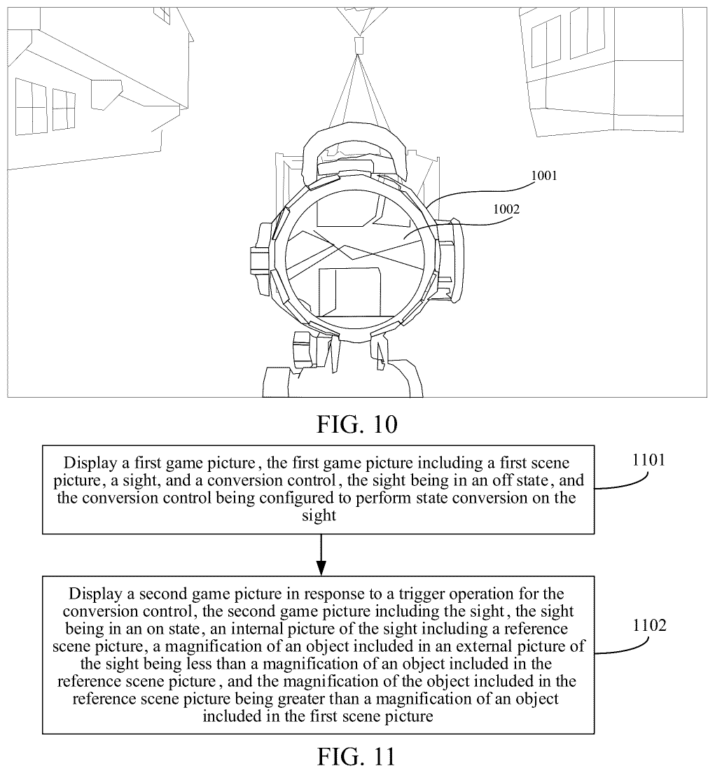

Alternatively, when the reference scene picture may be acquired in the first manner of acquiring the reference scene picture in operation 202 above, the external picture of the sight may be a picture other than the fourth scene picture in the third scene picture. The third scene picture may be obtained by adjusting the first scene picture. The process of acquiring the third scene picture has been described in operation 202, and details are not described herein again. FIG. 10 may be a schematic diagram of display of another second game picture. A sight 1001 may be displayed in the second game picture, the sight 1001 may be in an on state, an internal picture of the sight may be a reference scene picture 1002, and an external picture of the sight may be a picture other than a fourth scene picture in a third scene picture.

In some examples, the second game picture further includes a conversion control, the conversion control may be displayed in a first form, and the first form may be configured for indicating that the sight displayed in the second game picture may be in an on state. For example, “the conversion control may be displayed in a first form” means that the conversion control may be displayed in gray. Certainly, the second game picture may further include another control.

In the foregoing method, after the trigger operation for the conversion control may be received, the second scene picture that may be in the first scene picture and corresponds to the sight may be zoomed in, to obtain the reference scene picture, so that the size of the object included in the reference scene picture may be larger than the size of the object included in the first scene picture, and the second game picture may be displayed, the internal picture of the sight in the second game picture may be the reference scene picture, the external picture of the sight may be determined based on the first scene picture, and the size of the object included in the internal picture of the sight may be larger than the size of the object included in the external picture of the sight, so that zoom magnifications of the internal picture and the external picture of the sight are different, which achieves a difference between the inside and the outside of the sight and then improves a display effect of a game picture, thereby improving game experience of a game object. Moreover, in some implementations, since only the second scene picture that may be in the first scene picture and corresponds to the sight needs to be processed, the calculation amount of a scene picture may be smaller. There may be a lower requirement for the performance of the terminal device displaying the game picture, which can save resources.

Aspects described herein provide a game picture display method applicable to the foregoing implementation environment. by taking a flowchart of a game picture display method according to an aspect shown in FIG. 11 as an example, the method may be performed by the terminal device 101 in FIG. 1. As shown in FIG. 11, the method includes the following operation 1101 to operation 1102.

Operation 1101: Display a first game picture, the first game picture including a first scene picture, a sight, and a conversion control, the sight being in an off state, and the conversion control being configured to perform state conversion on the sight.

In a possible implementation, a process of displaying the first game picture may be similar to the process in operation 201 above, and details are not described herein again.

Operation 1102: Display a second game picture in response to a trigger operation for the conversion control, the second game picture including the sight, the sight being in an on state, an internal picture of the sight including a reference scene picture, a magnification of an object included in an external picture of the sight being less than a magnification of an object included in the reference scene picture, and the magnification of the object included in the reference scene picture being greater than a magnification of an object included in the first scene picture.

In a possible implementation, a process of displaying the second game picture may be similar to the process in operation 203 above, and details are not described herein again. A magnification of an object included in the external picture of the sight may be obtained based on a size of the object included in the external picture of the sight and a size of an object included in the first scene picture. For example, the magnification of the object included in the external picture of the sight may be a quotient between the size of the object included in the external picture of the sight and the size of the object included in the first scene picture. The magnification of the object included in the reference scene picture may be obtained based on a size of the object included in the reference scene picture and the size of the object included in the first scene picture. For example, the magnification of the object included in the reference scene picture may be a quotient between the size of the object included in the reference scene picture and the size of the object included in the first scene picture. For example, the magnification of the object included in the first scene picture may be 1. The size of the object included in the external picture of the sight may be smaller than the size of the object included in the reference scene picture, and the size of the object included in the reference scene picture may be larger than the size of the object included in the first scene picture.

In some examples, the magnification of the object included in the external picture of the sight in the second game picture may be greater than the magnification of the object included in the first scene picture, or the magnification of the object included in the external picture of the sight in the second game picture may be equal to the magnification of the object included in the first scene picture. A size of the object included in the external picture of the sight in the second game picture may be larger than the size of the object included in the first scene picture, or the size of the object included in the external picture of the sight in the second game picture may be equal to the size of the object included in the first scene picture.

In a possible implementation, the second game picture further includes a direction control, and the direction control may be configured to adjust a displayed game picture. After the second game picture may be displayed, a third game picture may be displayed in response to a trigger operation for the direction control. The third game picture includes the sight. The sight may be in an on state, an internal picture of the sight includes a fifth scene picture, a magnification of an object included in an external picture of the sight in the third game picture may be less than a magnification of an object included in the fifth scene picture, and the magnification of the object included in the fifth scene picture may be the same as the magnification of the object included in the reference scene picture. The magnification of the object included in the external picture of the sight included in the third game picture may be the same as the magnification of the object included in the external picture of the sight included in the second game picture.

For example, the fifth scene picture may be a scene picture on the side of a direction indicated by the direction control of the reference scene picture, or the fifth scene picture may be a scene picture in the direction indicated by the direction control. For example, if a direction indicated by the direction control included in the second game picture may be a left side, the internal picture of the sight (that is, the fifth scene picture) in the third game picture may be a scene picture on the left side of the reference scene picture.

In some examples, the second game picture further includes a conversion control, and the conversion control may be displayed in a first form. Alternatively, the second game picture further includes a conversion control in a first form, and the first form may be configured to indicate that the sight displayed in the second game picture may be in an on state. After the second game picture is displayed, the first game picture may be displayed in response to a trigger operation for the conversion control, and the conversion control displayed in the first game picture may be displayed in a second form. Alternatively, the first game picture includes a conversion control in a second form, and the second form may be configured to indicate that the sight displayed in the first game picture may be in an off state. The first form and the second form are not limited. For example, “the conversion control may be displayed in a first form” means that the conversion control may be displayed in gray, and “the conversion control may be displayed in a second form” means that the conversion control may be displayed in white.

In the foregoing method, after the trigger operation for the conversion control is received, the magnification of the object included in the internal picture of the sight in the displayed second game picture may be greater than the magnification of the object included in the external picture of the sight, so that zoom magnifications of the internal picture and the external picture of the sight are different, which achieves a difference between the inside and the outside of the sight and then improves a display effect of a game picture, thereby improving game experience of a game object.

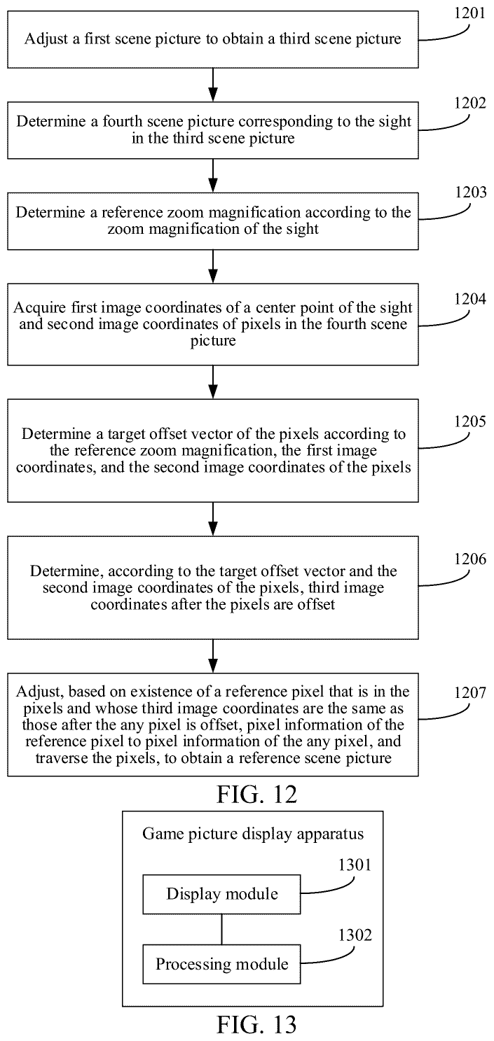

FIG. 12 may be a flowchart of a method for acquiring a reference scene picture. As shown in FIG. 12, the method includes the following operations:

Operation 1201: Adjust a first scene picture to obtain a third scene picture.

In a possible implementation, a size of an object included in the third scene picture may be larger than a size of an object included in the first scene picture, a size of the third scene picture may be reference zoom magnification times a size of the first scene picture, and the reference zoom magnification may be determined based on a zoom magnification of a sight.

Operation 1202: Determine a fourth scene picture corresponding to the sight in the third scene picture.

In a possible implementation, the fourth scene picture may be part of the third scene picture.

Operation 1203: Determine a reference zoom magnification according to the zoom magnification of the sight.

Operation 1204: Acquire first image coordinates of a center point of the sight and second image coordinates of pixels in the fourth scene picture.

Operation 1205: Determine a target offset vector of the pixels according to the reference zoom magnification, the first image coordinates, and the second image coordinates of the pixels.

Operation 1206: Determine, according to the target offset vector and the second image coordinates of the pixels, third image coordinates after the pixels are offset.

Operation 1207: Adjust, based on the existence of a reference pixel that may be in the pixels and whose third image coordinates are the same as those after the any pixel may be offset, pixel information of the reference pixel to pixel information of the any pixel, and traverse the pixels, to obtain a reference scene picture.

Implementations of operation 1201 to operation 1207 above have been described in operation 202 above, and details are not described herein again.

FIG. 13 may be a schematic structural diagram of a game picture display apparatus. As shown in FIG. 13, the apparatus includes:

a display module 1301 configured to display a first game picture, the first game picture including a first scene picture, a sight, and a conversion control, the sight being in an off state, and the conversion control being configured to perform state conversion on the sight; and

a processing module 1302 configured to process, in response to a trigger operation for the conversion control, the first scene picture according to a zoom magnification of the sight, to obtain a reference scene picture;

the display module 1301 being further configured to display a second game picture, the second game picture including the sight, the sight being in an on state, an internal picture of the sight including the reference scene picture, an external picture of the sight being obtained based on the first scene picture, and a size of an object included in the external picture of the sight being smaller than a size of an object included in the reference scene picture.

In a possible implementation, the processing module 1302 may be configured to adjust the first scene picture in response to the trigger operation for the conversion control, to obtain a third scene picture, a size of an object included in the third scene picture being larger than a size of an object included in the first scene picture; and process, according to the zoom magnification of the sight, a fourth scene picture that may be in the third scene picture and corresponds to the sight, to obtain the reference scene picture, the size of the object included in the reference scene picture being larger than a size of an object included in the fourth scene picture, and the external picture of the sight being a picture other than the fourth scene picture in the third scene picture.

In a possible implementation, the processing module 1302 may be configured to determine a reference zoom magnification according to a zoom magnification of the sight, the reference zoom magnification being a zoom magnification of the reference scene picture relative to the fourth scene picture; acquire first image coordinates of a center point of the sight and second image coordinates of pixels in the fourth scene picture; and adjust pixel information of the pixels according to the reference zoom magnification, the first image coordinates, and the second image coordinates of the pixels, to obtain the reference scene picture.

In a possible implementation, the processing module 1302 may be configured to determine, according to the reference zoom magnification, the first image coordinates, and the second image coordinates of the pixels, third image coordinates after the pixels are offset; and for any pixel in the pixels, adjust, based on the existence of a reference pixel that may be in the pixels and whose third image coordinates are the same as those after the any pixel may be offset, pixel information of the reference pixel to pixel information of the any pixel, and traverse the pixels, to obtain the reference scene picture.

In a possible implementation, the processing module 1302 may be configured to determine, for any pixel in the pixels, a target offset vector of the any pixel according to the reference zoom magnification, the first image coordinates, and the second image coordinates of the any pixel, the target offset vector of the any pixel being configured for indicating an offset between the second image coordinates of the any pixel and image coordinates of the any pixel that are zoomed in according to the reference zoom magnification, and the target offset vector of the any pixel including a first offset value of the any pixel in a first direction and a second offset value of the any pixel in a second direction; and determine, according to the second image coordinate of the any pixel, the first offset value of the any pixel in the first direction, and the second offset value of the any pixel in the second direction, the third image coordinates after the any pixel may be offset.

In a possible implementation, the processing module 1302 may be configured to determine a reference offset vector of the any pixel according to the reference zoom magnification, the first image coordinates, and the second image coordinates of the any pixel; and determine the target offset vector of the any pixel according to the reference offset vector of the any pixel in either of the following manners: taking the reference offset vector of the any pixel as the target offset vector of the any pixel; and determining the target offset vector of the any pixel according to the reference offset vector of the any pixel.

In a possible implementation, the processing module 1302 may be configured to determine an encoded intermediate vector of the any pixel according to the reference offset vector of the any pixel, and determine the target offset vector of the any pixel according to the encoded intermediate vector of the any pixel, the encoded intermediate vector being a vector obtained after normalization of the reference offset vector; or determine the target offset vector of the any pixel according to a fifth offset value and a sixth offset value included in the reference offset vector of the any pixel, the fifth offset value being an offset value of the any pixel in the first direction, and the sixth offset value being an offset value of the any pixel in the second direction.

In a possible implementation, the encoded intermediate vector of the any pixel includes a third offset value of the any pixel in the first direction and a fourth offset value of the any pixel in the second direction.

The processing module 1302 may be configured to encode the third offset value to obtain a first binary value, and encode the fourth offset value to obtain a second binary value, the first binary value and the second binary value having the same quantity of bits; acquire a third binary value and a fourth binary value according to the first binary value, and acquire a fifth binary value and a sixth binary value according to the second binary value; and determine the target offset vector of the any pixel according to the third binary value, the fourth binary value, the fifth binary value, and the sixth binary value.

In a possible implementation, the processing module 1302 may be configured to decode the third binary value to obtain a first value, decode the fourth binary value to obtain a second value, decode the fifth binary value to obtain a third value, and decode the sixth binary value to obtain a fourth value; and determine the target offset vector of the any pixel according to the first value, the second value, the third value, and the fourth value.

In a possible implementation, the processing module 1302 may be configured to determine a reference zoom magnification according to a zoom magnification of the sight, the reference zoom magnification being a zoom magnification of the reference scene picture relative to the fourth scene picture; stretch the fourth scene picture according to the reference zoom magnification, to obtain a first target scene picture, a size of the first target scene picture being reference zoom magnification times a size of the fourth scene picture; and clip the first target scene picture to obtain the reference scene picture, a center point of the reference scene picture being a center point of the first target scene picture, and a size of the reference scene picture being the same as a size of the internal picture of the sight.

In a possible implementation, the processing module 1302 may be configured to determine a target region by taking the center point of the first target scene picture as a center and a target length as a radius, the target length being a radius of the sight; and take a scene picture covered by the target region in the first target scene picture as the reference scene picture.

In a possible implementation, the processing module 1302 may be configured to determine a reference region by taking a center point of the third scene picture as a center and a target length as a radius, the target length being a radius of the sight; and take a scene picture covered by the reference region in the third scene picture as the fourth scene picture.

In a possible implementation, the processing module 1302 may be configured to acquire a first field of view corresponding to the first scene picture and a zoom magnification of the sight; determine a second field of view according to the first field of view and the zoom magnification of the sight (for example, the second field of view may be a field of view corresponding to a target zoom magnification corresponding to the zoom magnification of the sight); and adjust the first scene picture according to the second field of view, to obtain the third scene picture.

In a possible implementation, the processing module 1302 may be configured to determine a target zoom magnification corresponding to the zoom magnification of the sight, the target zoom magnification being a zoom magnification of the third scene picture relative to the first scene picture; determine a reference value according to the first field of view; determine a target value according to the reference value and the target zoom magnification; and determine the second field of view according to the target value.

In a possible implementation, the processing module 1302 may be configured to determine a target zoom magnification corresponding to the zoom magnification of the sight, the target zoom magnification being a zoom magnification of the third scene picture relative to the first scene picture; stretch the first scene picture according to the target zoom magnification, to obtain a second target scene picture, a size of the second target scene picture being target zoom magnification times a size of the first scene picture; and clip the second target scene picture to obtain the third scene picture, the center point of the third scene picture being a center point of the second target scene picture (for example, a size of the third scene picture may be the same as the size of the first scene picture).

In a possible implementation, the processing module 1302 may be configured to adjust, in response to the trigger operation for the conversion control, pixel information of pixels in the second scene picture according to the zoom magnification of the sight, first image coordinates of a center point of the sight, and fourth image coordinates of the pixels in the second scene picture, to obtain the reference scene picture; or stretch, in response to the trigger operation for the conversion control, the second scene picture according to the zoom magnification of the sight, to obtain a third target scene picture, and clip the third target scene picture to obtain the reference scene picture; The second scene picture may be a scene picture that may be in the first scene picture and corresponds to the sight, and the external picture of the sight may be a picture other than the second scene picture in the first scene picture.

According to the foregoing apparatus, after a trigger operation for the sight on control may be received, the first scene picture may be zoomed in, to obtain the reference scene picture, the second game picture may be displayed, the internal picture of the sight in the second game picture may be the reference scene picture, the external picture of the sight may be determined based on the first scene picture, and the size of the object included in the internal picture of the sight may be larger than the size of the object included in the external picture of the sight, so that zoom magnifications of the internal picture and the external picture of the sight are different, which achieves a difference between the inside and the outside of the sight and then improves a display effect of a game picture, thereby improving game experience of a game object. For example, in some implementations, since only the second scene picture that may be in the first scene picture and corresponds to the sight needs to be processed, a calculation amount of a scene picture may be smaller. There may be a lower requirement for the performance of the terminal device displaying the game picture, which can save resources.

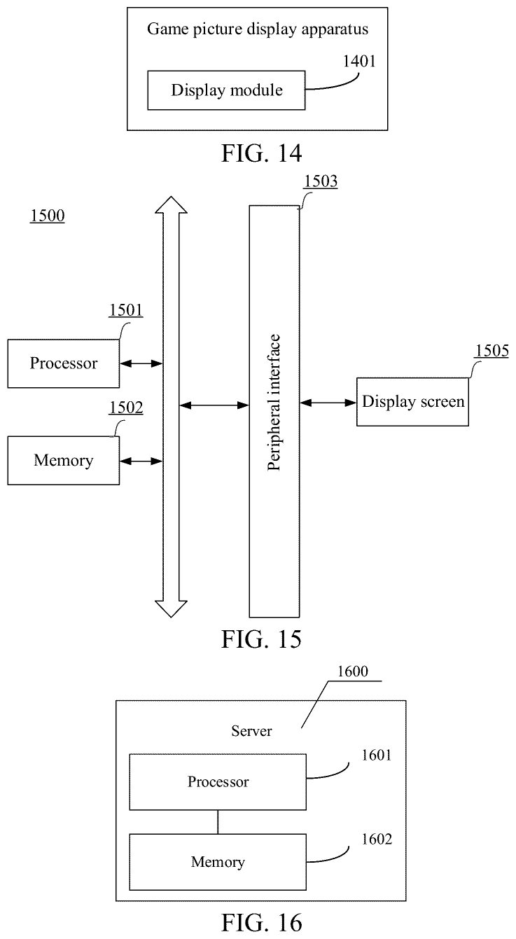

FIG. 14 may be a schematic structural diagram of a game picture display apparatus. As shown in FIG. 14, the apparatus includes:

a display module 1401 configured to display a first game picture, the first game picture including a first scene picture, a sight, and a conversion control, the sight being in an off state, and the conversion control being configured to perform state conversion on the sight;

the display module 1401 being further configured to display a second game picture in response to a trigger operation for the conversion control, the second game picture including the sight, the sight being in an on state, an internal picture of the sight including a reference scene picture, a magnification of an object included in an external picture of the sight being less than a magnification of an object included in the reference scene picture, and the magnification of the object included in the reference scene picture being greater than a magnification of an object included in the first scene picture.

In a possible implementation, the magnification of the object included in the external picture of the sight in the second game picture may be greater than the magnification of the object included in the first scene picture, or the magnification of the object included in the external picture of the sight in the second game picture may be equal to the magnification of the object included in the first scene picture.

In a possible implementation, the second game picture further includes a direction control, and the direction control may be configured to adjust a displayed game picture.

The display module 1401 may be further configured to display a third game picture in response to a trigger operation for the direction control. The third game picture includes the sight. The sight may be in an on state, an internal picture of the sight includes a fifth scene picture, a magnification of an object included in an external picture of the sight in the third game picture may be less than a magnification of an object included in the fifth scene picture, the magnification of the object included in the fifth scene picture may be the same as a magnification of an object included in the reference scene picture, and the fifth scene picture may be a scene picture on the side of a direction indicated by the direction control of the reference scene picture, or the fifth scene picture may be the scene picture in the direction indicated by the direction control.

In a possible implementation, the second game picture further includes a sight on control, and the sight on control may be displayed in a first form. Alternatively, the second game picture further includes a conversion control in a first form, and the first form may be configured to indicate that the sight displayed in the second game picture may be in an on state.

The display module 1401 may be further configured to display the first game picture in response to a trigger operation for the conversion control. The sight on control displayed in the first game picture may be displayed in a second form. Alternatively, the first game picture includes a conversion control in a second form, and the second form may be configured to indicate that the sight displayed in the first game picture may be in an off state.

In the foregoing apparatus, after the trigger operation for the sight on control may be received, the magnification of the object included in the internal picture of the sight in the displayed second game picture may be greater than the magnification of the object included in the external picture of the sight, so that zoom magnifications of the internal picture and the external picture of the sight are different, which achieves a difference between the inside and the outside of the sight and then improves a display effect of a game picture, thereby improving game experience of a game object.

When the apparatus provided above implements the functions of the apparatus, only division into the foregoing function modules may be used as an example for description. In the practical application, the functions may be allocated to and completed by different function modules according to requirements. That is, an internal structure of the device may be divided into different function modules to complete all or some of the functions described above. In addition, the apparatus provided in the foregoing examples belongs to the same concept. For details of a specific implementation process, reference may be made to the method examples. Details are not described herein again.

FIG. 15 shows a structural block diagram of a terminal device 1500. The terminal device 1500 may be a portable mobile terminal, such as a smartphone, a tablet computer, a moving picture experts group audio layer III (MP3) player, a moving picture experts group audio layer IV (MP4) player, a notebook computer, or a desktop computer. The terminal device 1500 may also be referred to by another name, such as user equipment, a portable terminal, a laptop terminal, or a desktop terminal.

Generally, the terminal device 1500 includes: a processor 1501 and a memory 1502.

The processor 1501 may include one or more processing cores, for example, a 4-core processor or an 8-core processor. The processor 1501 may be implemented in at least one hardware form of: a digital signal processor (DSP), a field-programmable gate array (FPGA), and a programmable logic array (PLA). The processor 1501 may alternatively include a main processor and a coprocessor. The main processor may be a processor configured to process data in an awakened state, which may also be referred to as a central processing unit (CPU). The coprocessor may be a low-power processor configured to process data in a standby state. In some examples, the processor 1501 may be integrated with a graphics processing unit (GPU). The GPU may be configured to render and draw content that needs to be displayed on a display screen. In some examples, the processor 1501 may further include an artificial intelligence (AI) processor. The AI processor may be configured to process computing operations related to machine learning.

The memory 1502 may include one or more non-transitory computer-readable storage media. The computer-readable storage medium may be non-transient (or non-transitory). The memory 1502 may further include a high-speed random access memory and a nonvolatile memory, for example, one or more disk storage devices or flash storage devices. In some examples, the non-transient computer-readable storage medium in the memory 1502 may be configured to store at least one instruction, and the at least one instruction may be configured for being executed by the processor 1501 to implement the game picture display method provided in the method examples.

In some examples, the terminal device 1500 may further include: a peripheral interface 1503 and at least one peripheral. The processor 1501, the memory 1502, and the peripheral interface 1503 may be connected through a bus or a signal cable. Each peripheral may be connected to the peripheral interface 1503 through a bus, a signal cable, or a circuit board. For example, the peripheral includes a display screen 1505.

The peripheral interface 1503 may be configured to connect the at least one peripheral related to input/output (I/O) to the processor 1501 and the memory 1502. In some examples, the processor 1501, the memory 1502, and the peripheral interface 1503 are integrated on the same chip or circuit board. In some other examples, any one or two of the processor 1501, the memory 1502, and the peripheral interface 1503 may be implemented on an independent chip or circuit board.

The display screen 1505 may be configured to display a user interface (UI). The UI may include a graph, text, an icon, a video, and any combination thereof. When the display screen 1505 may be a touch display screen, the display screen 1505 further has the capability of acquiring a touch signal on or above the surface of the display screen 1505. The touch signal may be inputted to the processor 1501 as a control signal for processing. In this case, the display screen 1505 may be further configured to provide a virtual button and/or a virtual keyboard that are/is also referred to as a soft button and/or a soft keyboard. In some examples, one display screen 1505 may be disposed on a front panel of the terminal device 1500. In some other examples, at least two display screens 1505 may be respectively disposed on different surfaces of the terminal device 1500 or folded. In some other examples, the display screen 1505 may be a flexible display screen disposed on a curved surface or a folded surface of the terminal device 1500. Even, the display screen 1505 may be further set in a non-rectangular irregular pattern, namely, a special-shaped screen. The display screen 1505 may be manufactured by using a material such as a liquid crystal display (LCD) or an organic light-emitting diode (OLED).

A person skilled in the art may understand that the structure shown in FIG. 15 constitutes no limitation on the terminal device 1500, and the terminal device may include more or fewer components than those shown in the figure, or some components may be combined, or a different component deployment may be used.

FIG. 16 may be a schematic structural diagram of a server. The server 1600 may vary a lot due to different configurations or performance and may include one or more CPUs 1601 and one or more memories 1602. The one or more memories 1602 store at least one instruction, and the at least one instruction may be loaded and executed by the one or more CPUs 1601 to implement the game picture display method provided in the foregoing method examples. Certainly, the server 1600 may further have components such as a wired or wireless network interface, a keyboard, and an input/output interface for input and output. The server 1600 may further include other components configured to implement device functions. Details are not described herein.

In an example, a non-transitory computer-readable storage medium may be further provided, the non-transitory computer-readable storage medium stores at least one program code, and the at least one program code may be loaded and executed by a processor, to cause a computer to implement any one of the foregoing the game picture display methods.

In some examples, the non-transitory computer-readable storage medium may be a read-only memory (ROM), a random access memory (RAM), a compact disc read-only memory (CD-ROM), a magnetic tape, a floppy disk, an optical data storage device, or the like.

In some examples, a computer program or a computer program product may be further provided, the computer program or the computer program product stores at least one computer instruction, and the at least one computer instruction may be loaded and executed by a processor, to cause a computer to implement any one of the foregoing the game picture display methods.

Information (including, but not limited to, user device information, user personal information, or the like), data (including, but not limited to, data configured for analysis, stored data, presented data, or the like), and signals as referred to in this application are all authorized by a user or fully authorized by various parties, and collection, use, and processing of related data need to comply with relevant laws, regulations, and standards of relevant regions. For example, the first game picture, as referred to in this application, may be acquired under full authorization.

“Plurality of” as referred to herein means two or more. “And/or” describes an association relationship that describes associated objects and represents that three relationships may exist. For example, A and/or B may represent the following three cases: only A exists, both A and B exist, and only B exists. The character “/” generally indicates an “or” relationship between the associated objects.

The sequence numbers of the foregoing examples are merely for description purposes but do not imply the preference among the examples.

The foregoing descriptions are merely examples of this application but are not intended to limit this application. Any modification, equivalent replacement, or improvement made within the principle of this application shall fall within the protection scope of this application.

What is claimed is:

1. A game picture display method, comprising:
displaying, by a terminal device, a first game picture, wherein the first game picture comprises a first scene picture, a sight, and a conversion control, wherein the sight is in an off state, and wherein the conversion control is configured to perform a state conversion on the sight;
receiving a trigger operation for the conversion control
generating, in response to the trigger operation and by processing the first scene picture according to a zoom magnification of the sight, a reference scene picture;
transitioning the sight to an on state;
generating an internal picture of the sight comprising the reference scene picture;
generating, based on the first scene picture, an external picture of the sight, wherein a size of a first object in the external picture of the sight is smaller than a size of a second object in the reference scene picture; and
transitioning from the first game picture to a second game picture, wherein the second game picture comprises the sight in the on state, the internal picture of the sight, and the external picture of the sight.

2. The method of claim 1, wherein the generating the reference scene picture comprises:
adjusting, in response to the trigger operation for the conversion control, the first scene picture to obtain a third scene picture, wherein a size of a third object in the third scene picture is larger than a size of a fourth object comprised in the first scene picture; and
generating, according to the zoom magnification of the sight, a fourth scene picture that is in the third scene picture and corresponds to the sight; and
generating the reference scene picture, wherein the size of the second object in the reference scene picture is larger than a size of a fifth object in the fourth scene picture, and wherein the external picture of the sight is different than the fourth scene picture in the third scene picture.

3. The method of claim 2, wherein the generating the reference scene picture further comprises:
determining a reference zoom magnification according to the zoom magnification of the sight, wherein the reference zoom magnification comprises a zoom magnification of the reference scene picture relative to the fourth scene picture;
acquiring first image coordinates of a center point of the sight and second image coordinates of a plurality of pixels in the fourth scene picture; and
adjusting pixel information of the plurality of pixels according to the reference zoom magnification, the first image coordinates, and the second image coordinates of the plurality of pixels.

4. The method of claim 3, wherein the adjusting the pixel information of the plurality of pixels comprises:
offsetting the plurality of pixels;
based on the reference zoom magnification, the first image coordinates, and the second image coordinates of the plurality of pixels, determining third image coordinates based on each of the plurality of pixels; and
for each pixel in the plurality of pixels, adjusting, based on an existence of a reference pixel in the plurality of pixels and based on the third image coordinates being the same as the pixel, the pixel information of the pixel; and
traversing the plurality of pixels to obtain the reference scene picture.

5. The method of claim 4, wherein the determining the third image coordinates for each of the plurality of pixels comprises:
for each pixel in the plurality of pixels:
determining a target offset vector of the pixel according to the reference zoom magnification, the first image coordinates, and the second image coordinates of the pixel, wherein the target offset vector of the pixel is configured for indicating an offset between the second image coordinates of the pixel and image coordinates of the pixel that are zoomed in according to the reference zoom magnification, and wherein the target offset vector of the pixel comprises a first offset value of the pixel in a first direction and a second offset value of the pixel in a second direction; and
based on the second image coordinate of the pixel, the first offset value of the pixel in the first direction and the second offset value of the pixel in the second direction,
determining the third image coordinates of the pixel.

6. The method of claim 5, wherein the determining the target offset vector of each pixel of the plurality of pixels comprises:
determining a reference offset vector of the pixel according to the reference zoom magnification, the first image coordinates, and the second image coordinates of the pixel; and
determining the target offset vector of the pixel according to the reference offset vector of the pixel.

7. The method of claim 6, wherein the determining the target offset vector of each pixel of the plurality of pixels comprises:
determining an encoded intermediate vector of the pixel according to the reference offset vector of the pixel; and
determining the target offset vector of the pixel according to the encoded intermediate vector of the pixel, wherein the encoded intermediate vector is a vector obtained after normalization of the reference offset vector.

8. The method of claim 7, wherein the encoded intermediate vector of each pixel of the plurality of pixels comprises a third offset value of the pixel in the first direction and a fourth offset value of the pixel in the second direction; and
wherein the determining the target offset vector of the pixel according to the encoded intermediate vector of the pixel comprises:
encoding the third offset value to obtain a first binary value;
encoding the fourth offset value to obtain a second binary value, wherein the first binary value and the second binary value have a same quantity of bits;
acquiring a third binary value and a fourth binary value according to the first binary value;
acquiring a fifth binary value and a sixth binary value according to the second binary value; and
determining the target offset vector of the pixel according to the third binary value, the fourth binary value, the fifth binary value, and the sixth binary value.

9. The method of claim 8, wherein the determining the target offset vector of each pixel of the plurality of pixels comprises:
decoding the third binary value to obtain a first value;
decoding the fourth binary value to obtain a second value;
decoding the fifth binary value to obtain a third value;
decoding the sixth binary value to obtain a fourth value; and
determining the target offset vector of the pixel according to the first value, the second value, the third value, and the fourth value.

10. The method of claim 2, wherein the generating the reference scene picture comprises:
determining a reference zoom magnification according to the zoom magnification of the sight, wherein the reference zoom magnification is a zoom magnification of the reference scene picture relative to the fourth scene picture;
stretching the fourth scene picture according to the reference zoom magnification to obtain a first target scene picture, wherein a size of the first target scene picture is the reference zoom magnification times a size of the fourth scene picture; and
clipping the first target scene picture to obtain the reference scene picture, wherein a center point of the reference scene picture is a center point of the first target scene picture, and wherein a size of the reference scene picture is the same as a size of the internal picture of the sight.

11. The method of claim 10, wherein the clipping comprises:
determining a target region by taking the center point of the first target scene picture as a center and a target length as a radius, wherein the target length is a radius of the sight; and
taking a scene picture covered by the target region in the first target scene picture as the reference scene picture.

12. The method of claim 2, wherein the adjusting the first scene picture to obtain a third scene picture comprises:
acquiring a first field of view corresponding to the first scene picture and the zoom magnification of the sight;
determining a second field of view according to the first field of view and the zoom magnification of the sight; and
adjusting, based on the second field of view, the first scene picture to obtain the third scene picture.

13. The method according to claim 12, wherein the determining the second field of view comprises:
determining a target zoom magnification corresponding to the zoom magnification of the sight, wherein the target zoom magnification is a zoom magnification of the third scene picture relative to the first scene picture;
determining a reference value according to the first field of view;
determining a target value according to the reference value and the target zoom magnification; and
determining the second field of view according to the target value.

14. The method of claim 2, wherein the adjusting the first scene picture to obtain the third scene picture comprises:
determining a target zoom magnification corresponding to the zoom magnification of the sight, wherein the target zoom magnification is a zoom magnification of the third scene picture relative to the first scene picture;
stretching the first scene picture according to the target zoom magnification to obtain a second target scene picture, wherein a size of the second target scene picture is the target zoom magnification times a size of the first scene picture; and
clipping the second target scene picture to obtain the third scene picture, wherein a center point of the third scene picture is a center point of the second target scene picture.

15. The method of claim 14, the generating the reference scene picture further comprises:
adjusting, in response to the trigger operation for the conversion control, pixel information of a plurality of pixels in the second target scene picture according to the zoom magnification of the sight, first image coordinates of a center point of the sight, and fourth image coordinates of the plurality of pixels in the second target scene picture,
wherein the second target scene picture is a scene picture that is in the first scene picture and corresponds to the sight; and
wherein the external picture of the sight is a picture other than the second target scene picture in the first scene picture.

16. One or more non-transitory computer readable media comprising computer readable instructions which, when executed, configure a data processing system to perform:
displaying a first game picture, wherein the first game picture comprises a first scene picture, a sight, and a conversion control, wherein the sight is in an off state, and wherein the conversion control is configured to perform a state conversion on the sight;
receiving a trigger operation for the conversion control
generating, in response to the trigger operation and by processing the first scene picture according to a zoom magnification of the sight, a reference scene picture;
transitioning the sight to an on state;
generating an internal picture of the sight comprising the reference scene picture;
generating, based on the first scene picture, an external picture of the sight, wherein a size of a first object in the external picture of the sight is smaller than a size of a second object in the reference scene picture; and
transitioning from the first game picture to a second game picture, wherein the second game picture comprises the sight in the on state, the internal picture of the sight, and the external picture of the sight.

17. The one or more non-transitory computer readable media of claim 16, wherein the computer readable instructions, when executed, further configure the data processing system to perform the generating the reference scene picture by:
adjusting, in response to the trigger operation for the conversion control, the first scene picture to obtain a third scene picture, wherein a size of a third object in the third scene picture is larger than a size of a fourth object comprised in the first scene picture; and
generating, according to the zoom magnification of the sight, a fourth scene picture that is in the third scene picture and corresponds to the sight; and
generating the reference scene picture, wherein the size of the second object in the reference scene picture is larger than a size of a fifth object in the fourth scene picture, and wherein the external picture of the sight is different than the fourth scene picture in the third scene picture.

18. The one or more non-transitory computer readable media of claim 17, wherein the computer readable instructions, when executed, further configure the data processing system to perform the generating the reference scene picture by:
determining a reference zoom magnification according to the zoom magnification of the sight, wherein the reference zoom magnification comprises a zoom magnification of the reference scene picture relative to the fourth scene picture;
acquiring first image coordinates of a center point of the sight and second image coordinates of a plurality of pixels in the fourth scene picture; and
adjusting pixel information of the plurality of pixels according to the reference zoom magnification, the first image coordinates, and the second image coordinates of the plurality of pixels.

19. The one or more non-transitory computer readable media of claim 17, wherein the computer readable instructions, when executed, further configure the data processing system to perform the generating the reference scene picture by:
determining a target zoom magnification corresponding to the zoom magnification of the sight, wherein the target zoom magnification is a zoom magnification of the third scene picture relative to the first scene picture;
stretching the first scene picture according to the target zoom magnification to obtain a second target scene picture, wherein a size of the second target scene picture is the target zoom magnification times a size of the first scene picture; and
clipping the second target scene picture to obtain the third scene picture, wherein a center point of the third scene picture is a center point of the second target scene picture.

20. An apparatus, comprising:
a processor; and
memory storing computer readable instructions which, when executed, configure the apparatus to perform:
displaying a first game picture, wherein the first game picture comprises a first scene picture, a sight, and a conversion control, wherein the sight is in an off state, and wherein the conversion control is configured to perform a state conversion on the sight;
receiving a trigger operation for the conversion control generating, in response to the trigger operation and by processing the first scene picture according to a zoom magnification of the sight, a reference scene picture;
transitioning the sight to an on state;
generating an internal picture of the sight comprising the reference scene picture;
generating, based on the first scene picture, an external picture of the sight, wherein a size of a first object in the external picture of the sight is smaller than a size of a second object in the reference scene picture; and
transitioning from the first game picture to a second game picture, wherein the second game picture comprises the sight in the on state, the internal picture of the sight, and the external picture of the sight.
